(19) United States
(12) Patent Application Publication
(10) Pub. No.: US 2008/0006576 A1
(43) Pub. Date: Jan. 10, 2008

(54) Aquarium purifier and aquarium purification method

(76) Inventors: Yoshifumi Suzuki, Osaka (JP); Kenji Horitsu, Osaka (JP); Yoshio Chiyoda, Osaka (JP)

Correspondence Address: JACOBSON HOLMAN PLLC, 400 SEVENTH STREET N.W., SUITE 600, WASHINGTON, DC, 20004, US

(21) Appl. No.: 11/819,585

(22) Filed: Jun. 28, 2007

(30) Foreign Application Priority Data
Jun. 29, 2006 (JP) 2006-179610
Apr. 5, 2007 (JP) 2007-099897

(51) Int. Cl. A01K 63/04; C02F 3/02

(52) U.S. Cl. 210/620; 210/137; 210/167.22

(57) ABSTRACT

The aquarium purifier of the invention includes a microaerophilic treatment tank and an aerobic treatment tank which microbiologically treat discharged water from an aquarium. Air in the discharged water is naturally deaerated in an introduction passage for the discharged water of the aquarium, the introduction passage communicating with the microaerophilic treatment tank. The discharged water of the aquarium is introduced from a lower section of the microaerophilic treatment tank. The microaeorphilic treatment tank and the aerobic treatment tank both are stored in an outer case. The microaerophilic treatment tank is provided with a culture bed container for denitrifiers placed therein and the aerobic treatment tank is provided with a pH control materials container placed therein. Above those, a physical filtering medium container for an ion exchange material is placed. The outer case is covered with a cover.

### BACKGROUND OF THE INVENTION

1. Field of the Invention

The present invention relates to an aquarium purifier in which reserved water of an aquarium for breeding aquarium fish, edible fish, shellfish, and the like is circulated to be purified and an aquarium purification method using the same.

2. Detailed Description of Prior Art

In the case of breeding and appreciating fish and shellfish and-the like in an aquarium, a water change is a material factor for water quality management. Reserved water in the aquarium is contaminated with ammonia component generated by excretory substance of fish, left-over food, dust and so on, which are factors of water contamination. Among those, the ammonia component and nitrite which is generated while the ammonia component is decomposed into nitrate by aerobes contained naturally in the reserved water are extremely hazardous to aquarium fish, and increase of the nitrate becomes factors of generation of algae and loosing of pH balance.

Therefore, various types of apparatus for circulating the reserved water in the aquarium to purify the reserved water chemically, physically, and microbiologically have been proposed. As for a microbiological purifier, the one composed of a combination of an anaerobic treatment tank and an aerobic treatment tank is generally known. However, such a microbiological purifier presently has drawbacks that an environmental maintenance for allowing microorganisms to act in each of the treatment tanks is difficult and thus satisfactory water quality is not obtainable.

Japanese Patent No. 2789296 discloses an apparatus in which reserved water in an aquarium is subjected to a denitrification treatment in a first filtering vessel having an anaerobic property, followed by being subjected to a nitrification treatment in a second filtering vessel having an aerobic property in order to perform an oxidative decomposition treatment to ammonia. This apparatus, however, includes a multi-layered various filtering medium in each of the first filtering vessel and the second filtering vessel, such that it has a complex structure as well as a difficulty in keeping the first filtering vessel having the anaerobic property in a perfect anaerobic condition. Therefore, the apparatus can not stably-keep the environment in which anaerobes become active. Also, since the apparatus has an air inflow device provided at a near side of the second filtering vessel having the aerobic property in order to keep the aerobic condition, the apparatus has drawbacks that the apparatus has a complex structure and an air amount control is difficult.

Also, Japanese Patent Laying-open No. 10-244290 discloses an apparatus having a wet filtering tank having an anaerobic property and a dry filtering tank having an aerobic property, in which reserved water of an aquarium is supplied to both tanks from above through a shower pipe. This apparatus, however, is structured such that the reserved water of the aquarium is supplied also to the wet filtering tank through the shower pipe. As such, there is a drawback that it is difficult to keep the inside of the wet filtering tank in a perfect anaerobic condition since ambient air may be involved.

### SUMMARY OF THE INVENTION

An object of the invention is to provide an aquarium purifier and an aquarium purification method in which hazardous components contained in discharged water of an aquarium are decomposed and purified microbiologically in a stable and efficient manner in the case where reserved water is circulated and purified continuously in the aquarium.

Another object of the invention is to provide an aquarium purifier and an aquarium purification method which can realize an optimum environment for breeding and activating microbes with a simple method and which has a high purification treatment ability.

Another object of the invention is to provide an aquarium purifier and an aquarium purification method which has a compact structure in its entirety, which can be manufactured at low cost, which can be assembled with ease, and which is inexpensive in after-maintenance.

Another object of the invention is to provide an aquarium purifier and an aquarium purification method which can produce every effect described in or predictable from the following embodiments and the attached drawings.

To achieve the above described objects, the present invention provides an aquarium purifier for purifying reserved water in the aquarium having a microaerophilic treatment tank and an aerobic treatment tank in order to subject the discharged water from the aquarium to a microbiological treatment.

The reserved water in the aquarium may be any one of fresh water, salt water (seawater), or brackish water. The aquarium may be either one of a household use aquarium or a business use aquarium. The microaerophilic treatment tank is a vessel for subjecting the discharged water to a microbiological treatment under the condition of lower dissolved oxygen rate, whereas the aerobic treatment tank is a vessel for subjecting the discharged water to a microbiological treatment under the condition of dissolved oxygen rate higher than the former. Any method can be employed in placing the discharged water in the aquarium under the microaerophilic condition or aerobic condition here. For example, air may be supplied to the microaerophilic treatment tank and the aerobic treatment tank while the air amount is controlled through an air supplying pump, such that each of the treatment tanks contains a predetermined dissolved oxygen amount. The microbilogical treatment device that hazardous components contained in the discharged water of the aquarium are subjected to a decomposed treatment until they become nonhazerdous components with a help of a metabolic and decomposing effect of the microbes.

) According to an embodiment of the invention, the aquarium purifier includes device for diverting the discharged water of the aquarium into the microaerophilic treatment tank and the aerobic treatment tank, device for directly directing the treatment water from the microaerophilic treatment tank to the aerobic treatment tank, and device for returning the treatment water from the aerobic treatment tank to the aquarium.

With the above described process, the discharged water of the aquarium can be treated separately through the microaerophilic treatment tank and the aerobic treatment tank, and therefore the discharged water treated in the microaerophilic treatment tank can be immediately subjected to the aerobic treatment in the aerobic treatment tank. As such, the hazardous components which could not be completely treated in the microaerophilic treatment tank can be converted into the nonhazardous components and thus the treatment water can be returned to the aquarium.

The device for diverting the discharged water into the microaerophilic treatment tank and the aerobic treatment tank can be realized by partitioning the vessel which receives the discharged water from the aquarium to form a microaerophilic treatment tank communication chamber and an aerobic treatment tank communication chamber. With such a simple structure, the discharged water of the aquarium can be diverged into the microaerophilic treatment tank and the aerobic treatment tank.

The device for conveying the discharged water from the microaerophilic treatment tank to the aerobic treatment tank may has such a structure that the discharged water is conveyed from the microaerophilic treatment tank to the aerobic treatment tank as a result of the overflow of the discharged water from the microaerophilic treatment tank. With such a structure, the discharged water can be conveyed from the microaerophilic treatment tank to the aerobic treatment tank smoothly by an appropriate amount of the discharged water with a simple method.

The device for returning-the treatment water of the aerobic treatment tank to the aquarium may have such a structure that the treatment water is pumped up from the aerobic treatment tank to the aquarium. This is the simple and inexpensive returning device.

) According to the invention, the aquarium purifier includes a deaeration device (air removal device) for naturally deaerating air in the discharged water draining through an introduction passage for the discharged water of the aquarium, the introduction passage communicating to the microaerophilic treatment tank.

Natural deaeration means that air contained in the discharged water of the aquarium is left to go up in the form of bubbles while the discharged water flows through the introduction passage to finally be released to the outside of the introduction passage for the discharged water. Therefore, a predetermined length of the introduction passage for the discharged water of the aquarium enables to deaerate air without resorting an additional device, resulting in a low manufacturing cost and a low maintenance cost.

According to the invention, the deaeration device has such a structure that it controls a flow rate at a water flow orifice which communicates to the introduction passage for the discharged water of the aquarium and introduces the controlled flow rate of the discharged water from the aquarium to the microaerophilic treatment tank at its lower section through the introduction passage for the discharged water of the aquarium.

Since the discharged water is introduced from the aquarium to the microaerophilic treatment tank through its lower section, air is deaerated from the discharged water while it reaches to the lower section of the microaerophilic treatment tank, and thus it becomes hard for the air involved in the discharged water of the aquarium to come into the microaerophilic treatment tank. As it will be set forth below, when a porosity filtering medium is filled within the microaerophilic treatment tank, the air trapped in a gap between the porosity filtering media tends to be deaerated together with the discharged water. Also, the discharged water from the aquarium comes to flow uniformly within the microaerophilic treatment tank.

Any flow rate controlling device may be employed here. That is, the flow rate controlling device may control the flow rate at the introduction passage for the discharged water of the aquarium using a valve, a clamp, or the like, or may control the flow rate at the introduction passage for the discharged water of the aquarium using a filter having a predetermined void ratio. As it is described above, an optimum control of the flow rate of the discharged water from the aquarium can constrain the involvement of the ambient air when the discharged water is introduced into the microaerophilic treatment tank from the aquarium.

According to the embodiment of the invention, the flow rate controlling device controls an opening area of the water flow orifice which communicates to the introduction passage for the discharged water of the aquarium. An optimum opening area of the water flow orifice will allow the discharged water from the aquarium to flow into the introduction passage for the discharged water of the aquarium at a slow speed, thereby being able to constrain the involvement of the air.

According to the invention, the microaerophilic treatment tank includes a culture bed containing a nutrient source necessary for denitrifiers.

In the microaerophilic treatment tank, a denitrification treatment using the denitrifiers is mainly performed. The denitrification is a reaction in which the denitrifiers breath using oxygen contained in nitrate ion (nitrate) or nitrite ion (nitrite) instead of oxygen to resolve the nitrate ion through nitrite ion to nitrogen gas N₁ (N₂O or NO). As for the denitrifier, genous Microccocus, genous pseudomonad, and the like are known in addition to sulfur oxidation denitrifier. Any of the above described denitrifiers may be used here. The culture bed contains an anorganic nutrient source or an organic nutrient source such as a carbon source, a nitrogen source, phosphate, or the like necessary for the denitrifiers.

If water reserved in the aquarium is seawater and if sea livings such as sea fish and actiniae are raised therein, the microaerophilic treatment tank should be filled with the culture bed containing the denitrifiers by an amount larger than the case where the reserved water is fresh water. This is because invertebrates such as actiniae are particularly sensitive to the nitrate. Therefore, seawater should be subjected to the denitrification treatment more than the case of the fresh water so as to dramatically reduce the nitrate (for example, 50 ppm in fresh water to be reduced up to 10 ppm in seawater).

According to the invention, the denitrifier is sulfur-oxidizing denitrifier and the nutrient source is a sulfur-calcium substrate.

The sulfur-oxidizing denitrifer is an nonpathogenic bacterium found in nature, which oxidizes the sulfur as the nutrient source using oxygen of nitrate-nitrogen (NO₃⁻) to generate nitrogen gas. At the time, the sulfur-oxidizing denitrifier discharges sulfate ion (SO₄²⁻) as a by-product, which, however, is bonded with calcium (Ca) contained in the sulfur-calcium substrate to create a stable calcium sulfate (CaSO⁴). The sulfur-calcium substrate is excellent in pH buffering ability, can be used in seawater and brackish water, and can be subjected to the denitrification treatment by the sulfur-oxidizing denitrifiers even under the condition of a temperature at 10 degrees or less.

According to the invention, the microaerophilic treatment tank and the aerobic treatment tank are filled with porosity filtering medium, respectively, and the porosity filtering medium of the aerobic treatment tank carries aerobes.

The porosity filtering medium may be any medium as far as it can carry bacteria in its pores. The porosity filtering medium includes, for example, porosity ceramic, poromiric plastic, foam, fiber, and the like. This porosity filtering medium may be held mainly aerobes and thus the aerobes in the microaerophilic treatment tank consume and reduce oxygen contained in the discharged water of the aquarium draining in the tank.

According to the embodiment of the invention, the porosity filtering medium includes clinker ashes. The clinker ash is a waste generated in the coal thermal power plant or the like. The clinker ash is generated such that ash contained in micro-fructured lime is burn at high temperature and blended particles are aggregated to form a porosity lump, resulting in falling down onto a hopper of a bottom section of a boiler. The clinker ash is excellent in water permeability as well as filtering ability owing to a number of fine pores it has, and is inexpensive to obtain.

According to the embodiment of the invention, the porosity filtering medium can be the one including calcium carbonate as main component. With such a filtering medium, the calcium carbonate solves out to the treatment water and thus the treatment water can be conditioned to be weak alkaline treatment water.

According to the embodiment of the invention, the porosity filtering medium may include coral particles. The coral particle is a porosity particle having a number of fine pores and has a property to solve out calcium, magnesium, or the like, to the treatment water to change the acidified treatment water to weak alkaline treatment water.

More specifically, in the case where the reserved water in the aquarium is the seawater, it is preferable to keep the seawater between pH 7.5 and pH 8.5 for breeding the sea livings. The coral particles can keep the above described pH range because the coral particles solve the calcium carbonate contained therein out to the treatment water. The calcium carbonate is a component essential for the sea livings to live.

The aerobes are microbes which live and grow by breathing oxygen under the condition of high dissolved oxygen rate, and thus a lot of chemoautotrophic bacteria, carbon fixed bacteria, and the like are included in the aerobes. The aerobes obtain energy by oxidizing inorganic materials and organic materials contained in the discharged water of the aquarium and also decompose dung, left-over food or the like of the breeding fish and the like which were flown into the aerobic treatment tank.

According to the invention, the aerobic bacteria are mostly nitrification bacteria. The nitrification bacteria, including nitric bacteria, are bacteria found in nature. The nitrification bacteria decompose ammonia component contained in the discharged water of the aquarium. The ammonia component is oxidized by nitric bacteria to nitrite ion (NO₂⁻), followed by being oxidized by the nitrification bacteria to nitrate ion (NO₃⁻). Nitorosomonas, nitrococcus are known as the nitric bacteria. Nitrobacter, nitrococcus are known as the nitrification bacteria.

According to the invention, the aerophilic treatment tank is provided with a water quality control materials. Accordingly, the treatment water to be returned to the aquarium can be changed to water suitable for the aquarium livings to live.

According to the embodiment of the invention, the water quality control materials is a pH control materials. The pH control materials can be any material and thus may include calcium carbonate, oyster shell, and the like to be used here. The calcium carbonate is available at low cost and can perform an effective pH adjusting of water by bringing it to contact with the water. This pH control materials can control the condition of water flown into the aerobic treatment tank suitable for activities of aerobes and therefore the treatment water to be returned to the aquarium can be controlled to have the pH condition suitable for the aquarium fish to live.

According to another embodiment of the invention, the water quality control materials is a mineral control materials. Accordingly, when sea livings are raised in seawater, components necessary for the sea livings to live are supplied and hazardous components can be removed. This mineral control materials includes phosphate adsorbent such as activated alumina. Since invertebrates as sea livings are sensitive to phosphoric acid (phosphate), removal of the phosphoric acid will be able to provide an environment suitable for invertebrates to live.

The aquarium reserved water purification method of the invention includes a process that the discharged water of the aquarium is treated under the microbiologically microaerophilic condition and a process that the discharged water of the aquarium is treated under the aerobic condition. The microaerophilic condition is a condition that the discharged water contains dissolved oxygen rate at least lower than that of the reserved water in the aquarium. The aerobic condition is a condition that the discharged water contains dissolved oxygen rate higher than that under the microaerophilic condition.

The method of the invention includes a process that the discharged water of the aquarium is subjected to a nitrification treatment in the process of the aerobic treatment and thus obtained treatment water is returned to the aquarium and a process that the discharged water of the aquarium is subjected to a denitrification treatment in the process of the microaerophilic treatment and thus nitrogen-removed water is further subjected to the aerobic treatment process.

The nitrification treatment is a treatment in which the ammonia component is microbiologically decomposed to nitrate ion (nitrate). The denitrification treatment is a treatment in which the nitrate ion is decomposed to nitrogen.

According to the method of the invention, the dissolved oxygen rate in the microaerophilic treatment tank is 5 mg/L or less. If the dissolved oxygen rate becomes more than 5 mg/L, the microaerophilic treatment tank is placed under the aerobic condition, resulting in lowering the activities of the denitrifiers or the like. The dissolved oxygen rate may substantially be 5 mg/L or less. However, the dissolved oxygen rate also may be slightly more than 5 mg/L as far as the microaerophilic treatment tank can provide an effective denitrification treatment function. Preferable dissolved oxygen rate is between 0.1 mg/L and 0.4 mg/L.

According to the embodiment of the invention, the dissolved oxygen rate in the aerobic treatment tank is 6 mg/L or more. If the dissolved oxygen rate becomes 6 mg/L or less, the activities of the nitrification bacteria in the aerobic treatment tank is lowered. The dissolved oxygen rate here may substantially be 6 mg/L or more. However, the dissolved oxygen rate also may be slightly less than 6 mg/L as far as the aerobic treatment tank can provide an effective nitrification treatment function.

The dissolved oxygen rate in the microaerophilic treatment tank is preferably reduced by 1 mg/L or more than the dissolved oxygen rate of the reserved water in the aquarium. The reserved water in the aquarium has a dissolved oxygen rate necessary for the aquarium fish to live. If the dissolved oxygen rate in the microaerophilic treatment tank is lowered by 1 mg/L or more than the former rate, the dissolved oxygen rate becomes suitable for the activities of the denitrifiers or the like.

According to the embodiment of the invention, the dissolved oxygen rate in the microaerophilic treatment tank is characterized in that the dissolved oxygen rate becomes lower from a lower section of the tank to an upper section of the tank. It is not necessary that the entirety of the inside of the tank is placed under the microaerophilic condition. In the case where the culture bed is placed above the microaerophilic treatment tank, it is satisfactory that the upper section of the tank is placed under the microaerophilic condition.

### BRIEF DESCRIPTION OF THE DRAWINGS

FIG. 1 is a schematic view of an entire aquarium purifier of the invention.

FIG. 2 is a schematic view of a cover tube constituting an upper water flow tube of the invention.

FIG. 3 is a front sectional view of the aquarium purifier of the invention.

FIG. 4 is a side sectional view of the aquarium purifier of the invention.

FIG. 5 is a perspective view of the entire appearance of the aquarium purifier of the invention.

FIG. 6 is an assembling perspective drawing of the components of the aquarium purifier of the invention.

FIG. 7 is a perspective view of an outer case of the aquarium purifier of the invention.

FIG. 8 is an enlarged view of A section in FIG. 4.

FIG. 9 is a perspective view of a microaerophilic treatment tank or an aerobic treatment tank of the aquarium purifier of the invention.

FIG. 10 is a perspective view of a culture bed container of the aquarium purifier of the invention.

FIG. 11 is a perspective view of a pH control materials container of the aquarium purifier of the invention.

FIG. 12 is a perspective view of a physical filtering medium container of the aquarium purifier of the invention.

FIG. 13 is a perspective view of a cover of the aquarium purifier of the invention.

FIG. 14 is a chart illustrating a result of a water quality survey of the reserved water in the aquarium according to an embodiment of the invention.

FIG. 15 is a schematic view illustrating the aquarium purifier using seawater according to the invention.

FIG. 16 is a chart illustrating a result of a water quality survey of the reserved water in the aquarium using seawater according to the invention.

### DESCRIPTION OF PREFERRED EMBODIMENTS

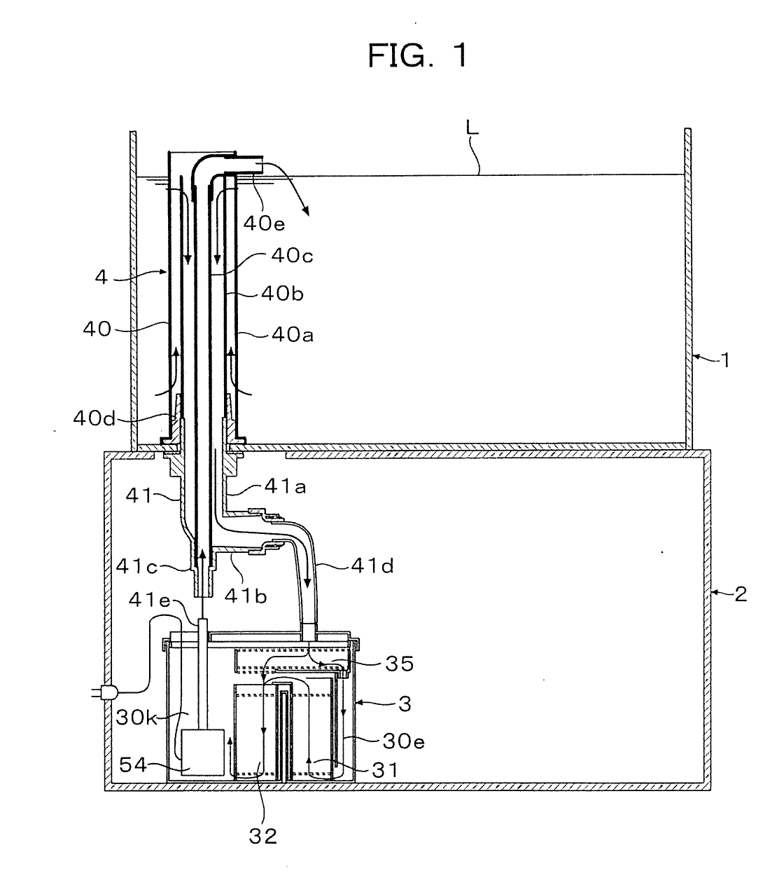

An embodiment of the invention will be described below with reference to the accompanying drawings. FIG. 1 is a schematic view of an entire aquarium purifier system of the invention, which includes an aquarium 1 made of a transparent or translucent material such as a plastic material, a glass material, or the like, base 2 for supporting this aquarium 1, and an aquarium purifier 3 disposed inside the base 2. The aquarium 1 communicates with the aquarium purifier 3 through a water flow tube 4 so as to introduce reserved water in the aquarium 1 into the aquarium purifier 3. Then, treatment water thus purified by the purifier 3 is returned to the aquarium 1.

The water flow tube 4 has an upper water flow tube 40 of a side of the aquarium 1 and a lower water flow tube 41 of a side of the base 2, in which the upper water flow tube 40 has a treble structure including a cover tube 40a, a drain tube 40b, and a water supply tube 40c. The cover tube 40a and the drain tube 40b are attached to a cylindrical connection member 40d which is attached to a bottom opening of the aquarium 1 in a water tight manner.

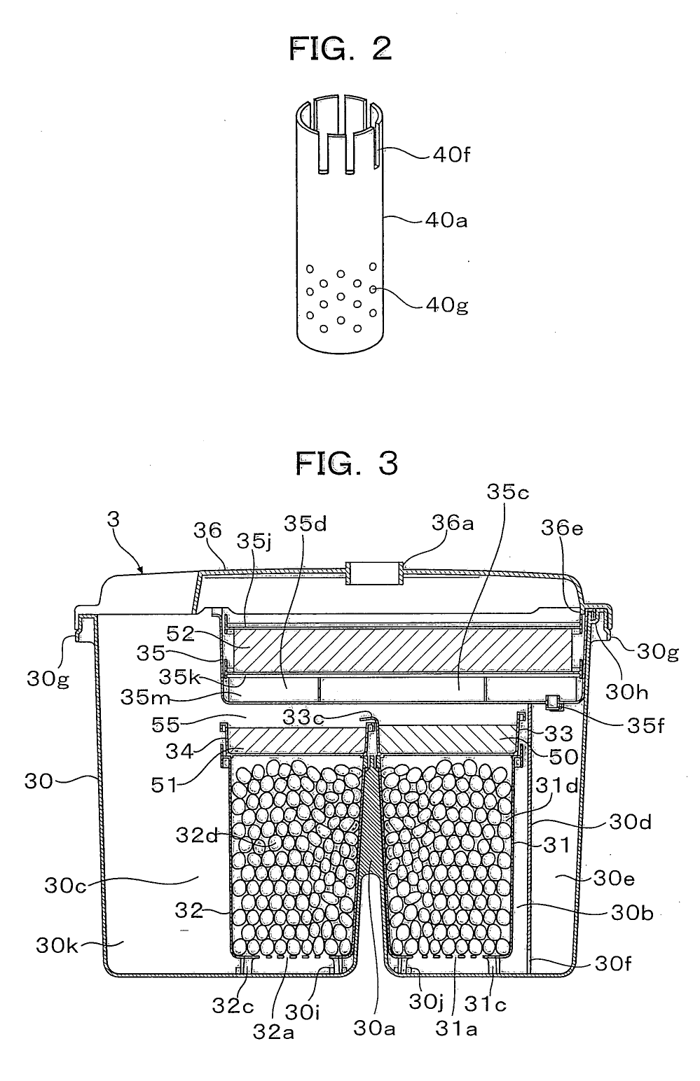

Both of an upper end and a lower end of the cover tube 40a are provided with a number of small holes or slit-like water intake openings 40f, 40g formed thereon as illustrated in FIG. 2. The reserved water around a water surface L flows from the aquarium into the water intake openings 40f at the upper end of the cover tube in order to keep the water surface L at a constant height. The reserved water around a bottom of the aquarium 1 flows into the water intake openings 40g at the lower end of the cover tube.

The reserved water flown in through water intake openings 40f, 40g overflows into the drain tube 40b from its upper end through a space between the cover tube 40a and the drain tube 40b, and then flows into the aquarium purifier 3 from the lower water flow tube 41, which will be described below, through a space between the drain tube 40b and the water supply tube 40c. An upper end of the water supply tube 40c is provided with a water discharge tube 40e connected therewith.

The lower water flow tube 41 has a cylindrical connection member 41a which is connectable to the connection member 40d at the side of the aquarium 1 in a water tight manner. This connection member 41a includes a diverging tube 41b communicating with the aquarium purifier 3 and a diverging tube 41c communicating with a water supply pump 54 which will be described below. The diverging tube 41b is provided with a connection tube 41d to be connected to the aquarium purifier 3 and the diverging tube 41c is provided with a connection tube 41e to be connected to the water supply pump 54.

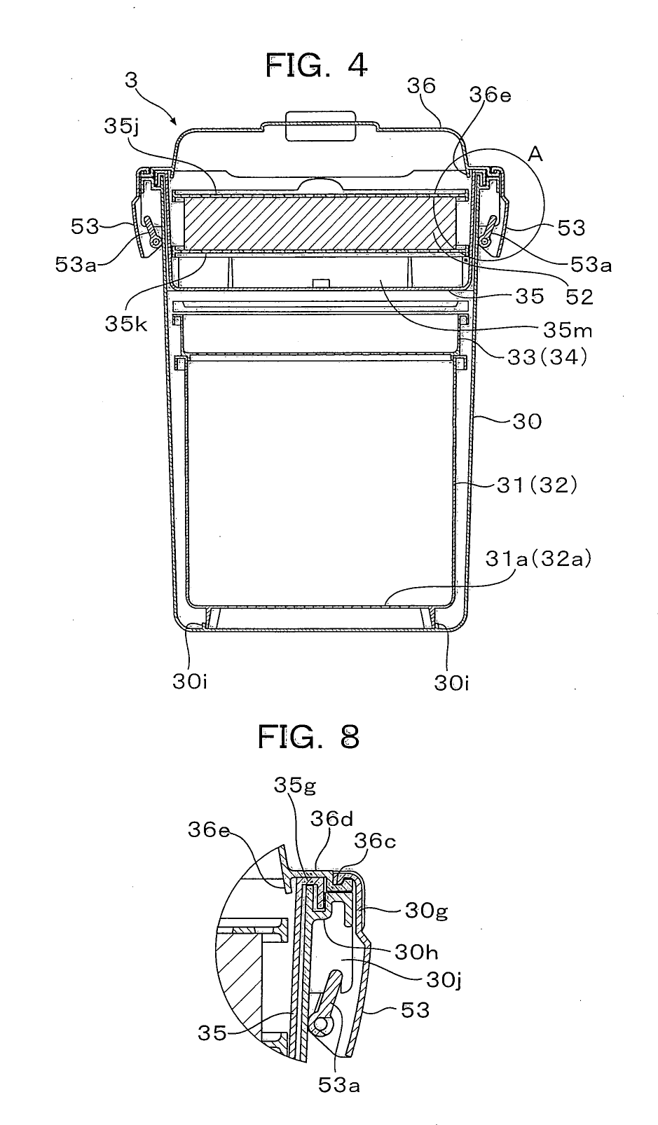

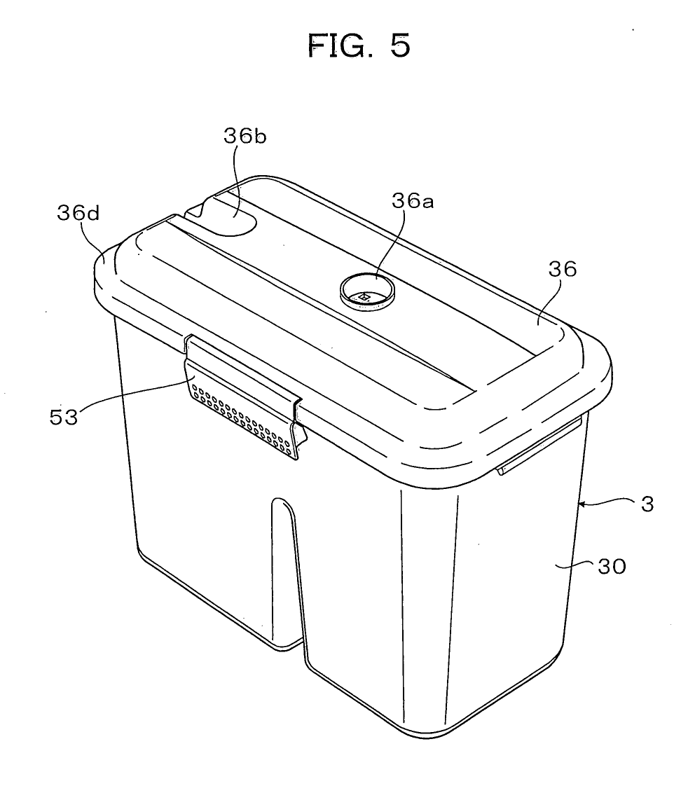

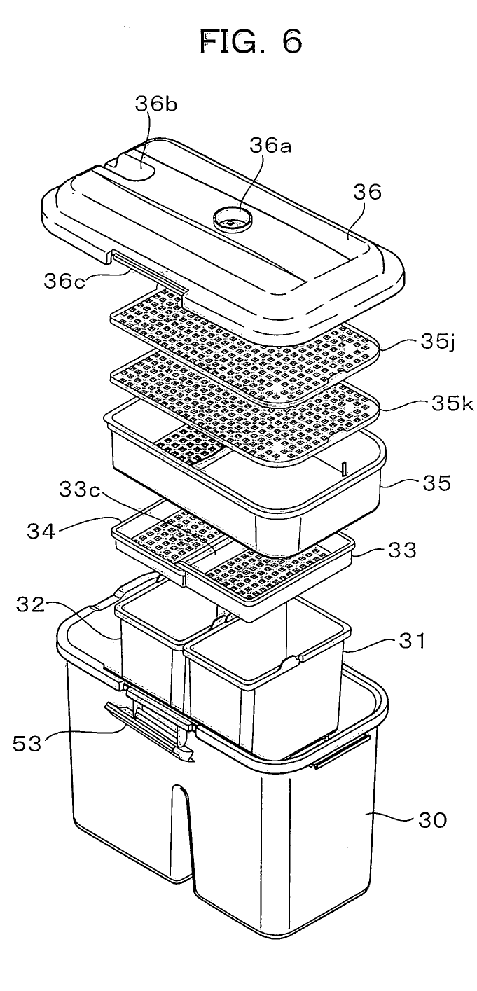

FIG. 3 is a front sectional view of the aquarium purifier 3; FIG. 4 is a side sectional view of the aquarium purifier 3; FIG. 5 is a perspective view of an entire appearance of the aquarium purifier 3; and FIG. 6 is an assembling perspective view of components of the aquarium purifier 3.

The aquarium purifier 3 has a box-like shape in its entirety and includes an outer case 30, a microaerophilic treatment tank 31 and an aerobic treatment tank 32 both stored inside the outer case, a culture bed container 33 placed above the microaerophilic treatment tank 31, a pH control materials container 34 placed above the aerobic treatment tank 32, a physical filtering medium container 35 placed above the respective containers 33, 34, and a cover 36 for covering a top of the outer case 30.

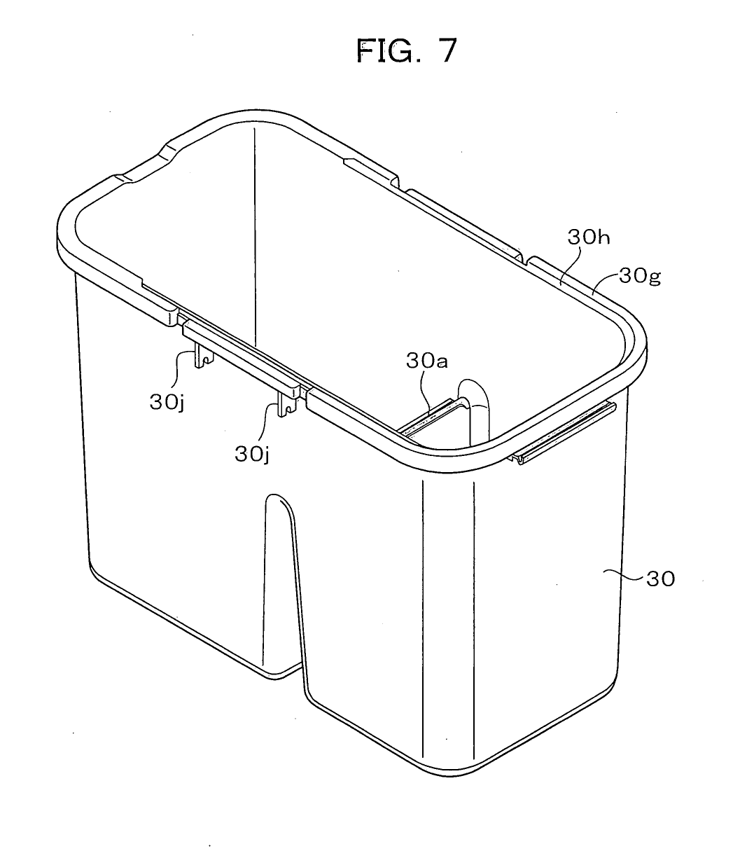

The outer case 30 is a box-like container in its entirety as shown in FIG. 7 and is provided with a projecting partition 30a formed therein such that a portion of the container slightly to one side from a center of the outer case projects into the inside of the outer case. In other words, as shown in FIG. 3, a portion of a bottom surface of the outer case is pressed in an inside direction of the outer case, thereby forming the separation 30a having almost the same height as the each of the treatment tanks 31, 32 within the outer case 30 in a width direction thereof.

With this separation 30a, the inside of the outer case 30, as shown in FIG. 3, is separated into a microaerophilic treatment chamber 30b and an aerobic treatment chamber 30c, such that the discharged water of the aquarium will not be blended with the treatment water in the aerobic treatment tank 32 when the discharged water is introduced into the microaerophilic treatment tank 31, as described below. A space adjacent to the aerobic treatment tank 32 works as a reserving section 30k of the treatment water having passed through the aerobic treatment tank 32. The reserving section 30k is provided with a water supply pump 54 (see FIG. 1).

As shown in FIG. 3, the microaerophilic treatment chamber 30b within the outer case 30 is provided with a partition board 30d in a height direction of the outer case and an introduction passage 30e for the discharged water of the aquarium between the partition board and one side surface of the outer case 30. The partition board 30d has a distribution opening 30f for the discharged water from the aquarium at a lower end of the partition board.

As shown in FIG. 7, an inside surface of an upper edge 30g of the outer case 30 is provided with a concaved portion 30h for engaging an upper edge of a physical filtering medium container 35 in such a manner that the concaved portion corresponds to a position at which the container 35 is placed. A pair of pivoting sections 30j, 30j as shown in FIG. 7 are formed at upper portions of both side surfaces of the outer case 30 in a width direction thereof. These pivoting sections 30j, 30j receive buckles 53 as shown in FIGS. 4 and 8 through pivoting members 53a, respectively, in a pivotable manner. As illustrated in FIGS. 3 and 4, a bottom surface of the inside of the outer case 30 is provided with positioning projections 30i, 30i for positioning the microaerophilic treatment tank 31 and the aerobic treatment tank 32.

The outer case 30 is made of a transparent or translucent plastic material and is formed into one piece by an injection molding with the partition 30a and the partition board 30d.

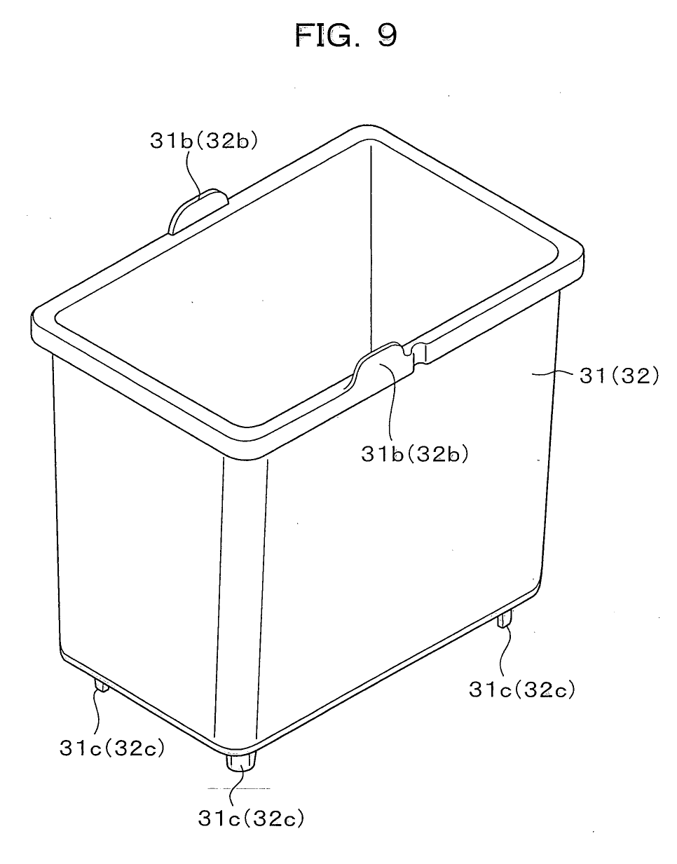

The microaerophilic treatment tank 31 and the aerobic treatment tank 32 are formed into deep containers having the same box-like shapes as shown in FIG. 9, and include a number of small holes or water through openings 31a, 32a in their bottom surfaces as shown in FIGS. 3 and 4. As shown in FIG. 9, locking pieces 31b, 32b for the culture bed container 33 are provided on an upper edge of each of the treatment tanks 31, 32. Each of the treatment tanks 31, 32 includes on its bottom surface legs 31c, 32c in a projecting manner.

The microaerophilic treatment tank 31 and the aerobic treatment tank 32 both are made of a transparent or translucent plastic material and are formed into one piece through the injection molding. Since the microaerophilic treatment tank 31 and the aerobic treatment tank 32 have the same shape and thus can be formed with one die, resulting in reducing the manufacturing cost.

The microaerophilic treatment tank 31 and the aerobic treatment tank 32 are filled with a number of clinker ashes 31d, 32d. The clinker ashes 31d, 32d serve as filtering medium for the discharged water of the aquarium as well as hold aerobic bacteria mainly which are contained in the discharged water of the aquarium. Commercially available nitrification bacteria are mixed in the aerobic treatment tank 32 and are held in the clinker ash 32d to be proliferated.

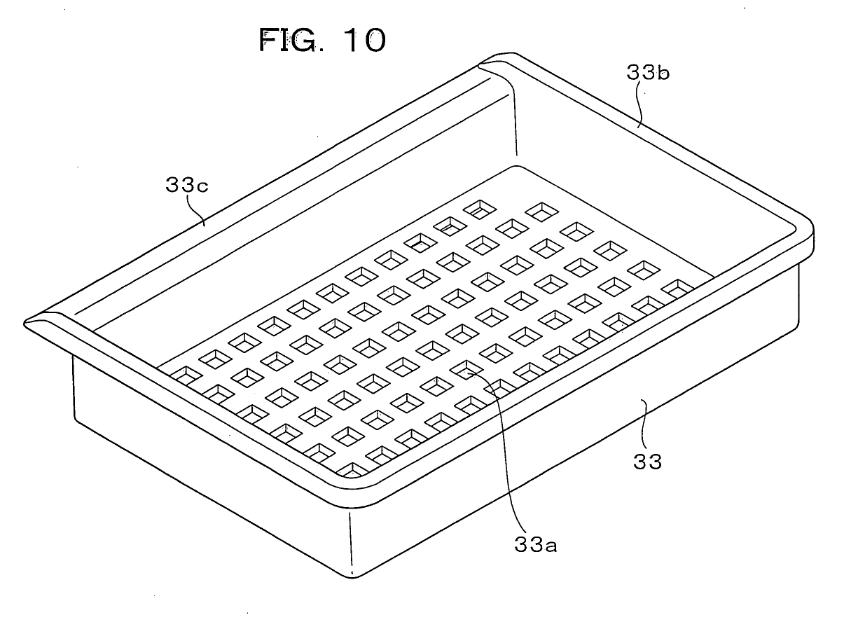

The culture bed container 33 placed on the microaerophilic treatment tank 31 is a shallow tray-like container in its entirety and includes a number of water through openings 33a in throughout a bottom surface thereof as shown in FIG. 10. One side of an upper edge 33b of the culture bed container is formed into an inclined surface 33c which slightly inclines downwardly and extends outwardly.

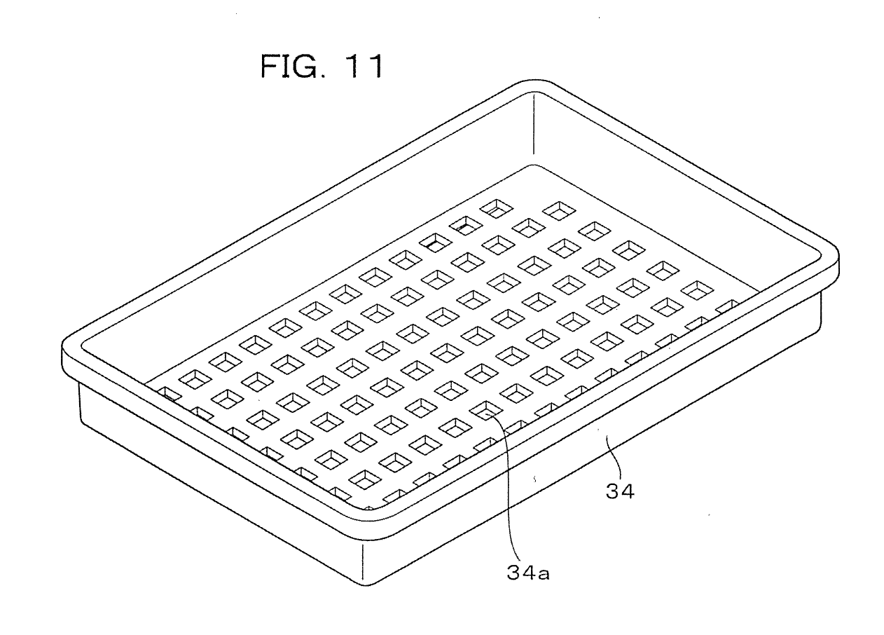

The pH control materials container 34 to be placed on the aerobic treatment tank 32 is a shallow tray-like container slightly lower than the culture bed container 33 and includes a number of water through openings 34a in throughout a bottom surface thereof as shown in FIG. 11.

The culture bed container 33 and the pH control materials container 34 both are also made of a transparent or translucent plastic material and are formed into one piece through the injection molding.

The culture bed container 33 contains a sulfur-calcium substrate culture bed 50 as shown in FIG. 3. The culture bed 50 is a particulate matter or a lump matter consisting mainly of calcium carbonate and sulfur and having fine voids, such that it can effectively carry sulfur-oxidizing denitrifiers in those fine voids.

The sulfur-oxidizing denitrifier is a facultative anaerobe and works to reduce nitrate-nitrogen (NO₃⁻) to nitrogen gas (N₂). That is, the sulfur-oxidizing denitrifier oxidizes the sulfur as a nutrient source by using oxygen of the nitrate-nitrogen to breath out nonhazardous nitrogen gas. As a result thereof, sulfate ion (SO₄²⁻) is discharged as a side product, which, however, is bonded with calcium (Ca) contained in the substrate to become a stable calcium sulfate (CaSO₄). The calcium sulfate is consisted mainly of calcium carbonate, such that pH balance of the treatment water can be kept in a good condition.

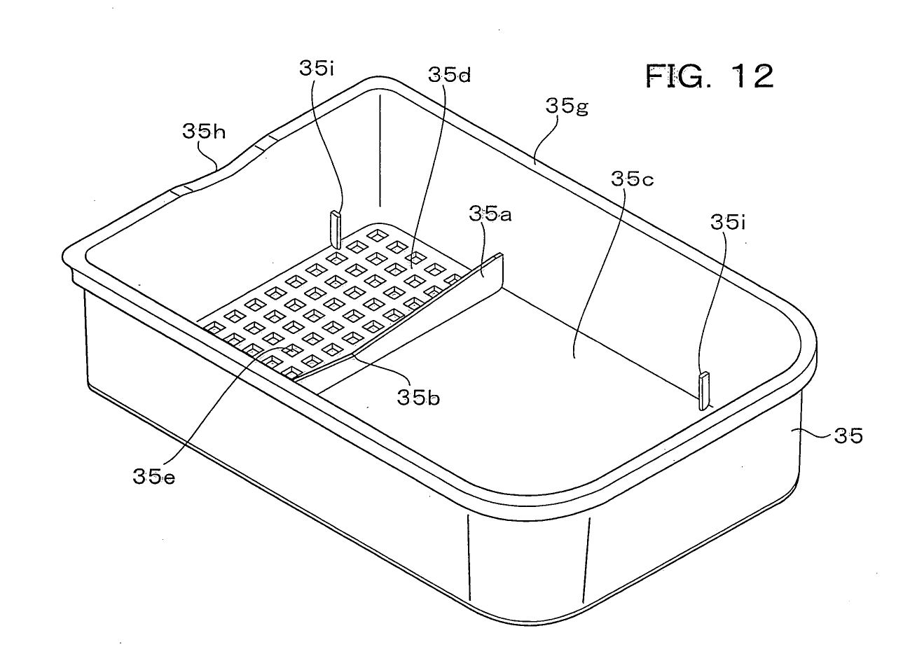

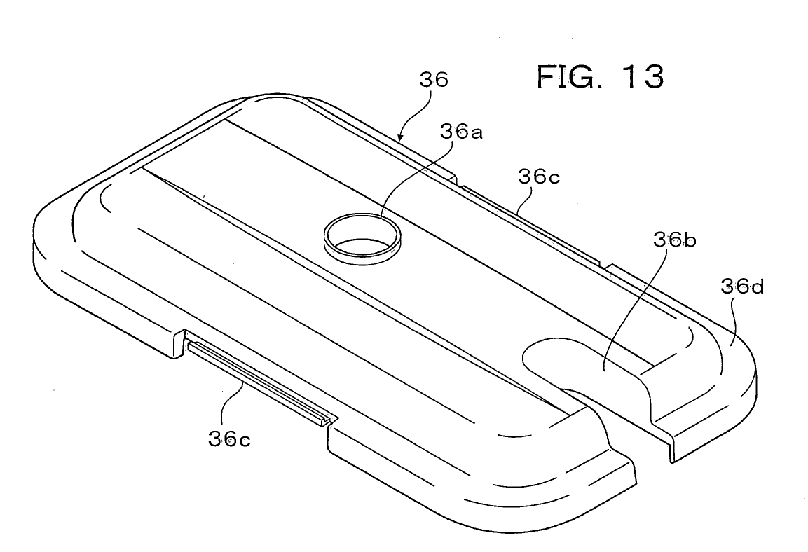

The pH control materials container 34 contains a pH control materials 51 such as calcium carbonate as shown in FIG. 3, thereby controlling the pH balance of the discharged water from the aquarium into the aerobic treatment tank 32 and the treatment water from the microaerophilic treatment tank 31. Accordingly, it is possible to keep an optimum pH environment for the activities of the aerobes in the aerobic treatment tank 32 as well as to keep an optimum pH environment (pH 6-8) of the treatment water to be returned to the aquarium 1 in a condition that the aquarium fish can live in the treatment water. The physical filtering medium container 35, as shown in FIG. 12, is a box-like container in its entirety and includes a baffle board 35a projecting from a bottom surface of the inside of the container in a width direction thereof, thereby partitioning the container into the microaerophilic treatment tank communicating chamber 35c and the aerobic treatment tank communicating chamber 35d. The baffle board 35a includes a low section 35b at a position slightly toward one side from a center of the baffle board in a longitudinal direction. The reserved water of a side of the microaerophilic treatment tank communicating chamber 35c flows into a side of the aerobic treatment tank communicating chamber 35d over the low section 35b. The baffle board 35a is positioned slightly toward a side of the aerobic treatment tank communicating chamber 35d.

The aerobic treatment tank communicating chamber 35d has a number of water through openings 35e in its bottom surface. The microaerophilic treatment tank communicating chamber 35c includes a water flow orifice 35f at one side end of a bottom surface section of the chamber as shown in FIG. 3. The water flow orifice 35f controls a water flow rate from the microaerophilic treatment tank communicating chamber 35c by making an opening area (diameter) small, thereby allowing the discharged water of the aquarium to drop into the introduction passage 30e at a slow speed. The diameter of the water flow orifice 35f is between 3 mm and 5 mm.

The upper edge 35g of the physical filtering medium container 35 is bent downwardly as illustrated in FIG. 8, and therefore it can be engaged into the concaved portion 30h of the upper edge of the outer case 30. Also, as shown in FIG. 12, an upper edge of a side surface of the aerobic treatment tank communication chamber 35d is provided with a discharged water flow-out section 35h having a gradually concaved shape. At proper places on the side surface of the inside of the physical filtering medium container 35 are provided with a plurality of support ribs 35i for supporting a physical filtering medium 52 which will be described below.

The physical filtering medium container 35 contains therein a physical filtering medium 52 which is sandwiched between two porous plates 35j, 35k such as an upper porous plate and a lower porous plate as shown in FIGS. 3 and 4. Particles of ion exchange resin are used here as the physical filtering medium 52. The porous plates 35j, 35k are flat plates with a number of water through openings as illustrated in FIG. 6. The lower porous plate 35k is supported by the support ribs 35i inside the physical filtering medium container 35. As a result thereof, as shown in FIGS. 3 and 4, a space 35m is formed below the physical filtering medium 52 which is sandwiched between the porous plates 35j, 35k.

The physical filtering medium container 35 and the porous plates 35j, 35k both are made of a transparent or translucent plastic material and are formed into one piece through the injection molding.

As shown in FIG. 13, the cover 36 is a flat coronal cap of which upper surface is formed into a convex shape and includes at a center of the upper surface an insertion opening 36a for the connection tube 41d which introduces the discharged water from the aquarium and an elongated hole-like notch 36b at one side end of the upper surface of the cover in a longitudinal direction. An elongated groove-like buckle locking sections 36c are formed at both side ends in a width direction of the cover.

A periphery 36d of the cover 36 covers over the upper edge 30g of the outer case 30. As shown in FIG. 8, boundary of the periphery 36d of a backside surface of the cover 36 is provided with a water drop guiding piece 36e in a downwardly projecting manner. Accordingly, water drops on the backside surface of the cover 36 will drop down along the water drop guiding piece 36e.

With the cover 36 covering over the top opening of the outer case 30, a noise insulation effect of the water supply pump 54 or the like and a heat retention effect for the inside of the case 30 can be produced and the discharged water of the aquarium or the like can be prevented from being evaporated and splashed out from the inside of the case 30. Additionally, the cover serves to prevent bacteria floating around the aquarium purifier from being contaminated into the outer case, thereby avoiding to loose an eco-balance of bacteria and to prevent the purification system from going out. The cover 36 is also made of a transparent or translucent plastic material and is formed into one piece through the injection molding.

In the case of assembling the above described aquarium purifier 3, the microaerophilic treatment tank 31 and the aerobic treatment tank 32 are initially stored in the outer case 30 side by side as shown in FIG. 6. At the time, the microaerophilic treatment tank 31 is stored in the outer case so as to be adjacent to the partition board 30d as well as the legs 31c, 32c of the treatment tanks 31, 32 are aligned with the positioning projections 30i, 30i. The microaerophilic treatment tank 31 and the aerobic treatment tank 32 are filled with clinker ashes 31d, 32d and commercially available nitrification bacteria are mixed into the aerobic treatment tank 32.

The culture bed container 33 is placed on the microaerophilic treatment tank 31 and the pH control materials container 34 is placed on the aerobic treatment tank 32. In this case, the inclined surface 33c of the culture bed container 33 is positioned on a top of the upper edge of the pH control materials container 34 as shown in FIG. 3. The culture bed container 33 is provided with a culture bed 50 which holds the denitrifiers and the pH control materials container 34 is provided with the pH control materials 51 such as calcium carbonate.

The upper edge 35g of the physical filtering medium container 35 is engaged in the concaved portion 30h of the upper edge of the outer case 30 so as to allow the physical filtering medium container to be supported by the outer case 30. The physical filtering medium container 35 contains the physical filtering medium 52, such as the ion exchange resin, which is sandwiched between the upper and the lower porous plates 35i, 35k.

The reserving section 30k of the side of the aerobic treatment tank communication chamber 30c of the outer case 30 includes the water supply pump 54 disposed therein as shown in FIG. 1. A connection tube 41e of the water supply pump 54 is inserted into the notch portion 36b of the cover 36 when the cover 36 is placed over the outer case.

When the cover 36 is placed over the outer case 30, the upper end claws of the buckles 53 are engaged in the buckle locking sections 36c to press down the buckles 53 as shown in FIGS. 3, 4 and 8. Accordingly, the cover 36 is locked over the upper edge 30g of the outer case 30 as well as the upper edge 35g of the physical filtering medium container 35 is locked with the upper edge 35g, with the upper edge 35g being engaged in the concaved portion 30h of the upper edge of the outer case.

After the cover 36 is placed over the outer case, the connection tube 41d to be connected to the lower water flow diverging tube 41b is inserted into the insertion opening 36a for the connection tube to establish a connection therebetween. The connection tube 41e of the water supply pump 54 is connected to the water supply diverging tube 41 of the lower water flow tube 41. At the time, since the notch 36e of the cover has an elongated hole shape, there is a looseness of the movement of the connection tube 41e. Therefore, the connection tube 41e is readily removable.

An aquarium purification method using the above described aquarium purifier 3 will be described below. As shown in FIG. 1, the reserved water of the aquarium 1 flows through the lower water intake openings 40g of the cover tube 40a of the upper water flow tube 40 into a flow passage formed between the cover tube 40a and the drain tube 40b. This flown-in water overflows from the upper end of the drain tube 40b to further flow to the downstream of the passage between the water supply tube 40c and the drain tube 40b. The flown-in water further flows through the discharged water diverging tube 41b and the connection tube 41d of the lower water flow tube 41 to flow into the aquarium purifier 3. The upper water intake openings 40f of the cover tube 40a are provided in order to keep the height of the water surface L of the reserved water in the aquarium 1 at a certain level, and therefore the reserved water flown in from the upper water intake openings 40f also flows through the same passage to finally flow into the aquarium purifier 3.

In the aquarium purifier 3, the discharged water of the aquarium flown in from the insertion opening 36a for the connection tube is physically filtered through the physical filtering medium 52 in the physical filtering medium container 35. The upper and the lower porous plates 35i, 35k which keep the physical filtering medium 52 therebetween will distribute water over the physical filtering medium 52 to allow the water to contact the physical filtering medium 52 uniformly and distribute the water flown out through the physical filtering medium 52 uniformly.

Through the physical filtering medium 52, foreign matters such as dung, left-over food, and dust which are contained in the discharged water of the aquarium are removed using a number of particles of the ion exchange resin and calcium ion in the discharged water of the aquarium is removed to discharge sodium ion and hydrogen ion.

The water flown out through the physical filtering medium 52 drops into the space 35m of the physical filtering medium container 35 to be distributed to the microaerophilic treatment tank communication chamber 35c and the aerobic treatment tank communication chamber 35d. The discharged water dropped into the side of the aerobic treatment tank communication chamber 35d immediately flows out through a number of water through openings 35e into the side of the aerobic treatment tank 32, whereas, the discharged water dropped in the side of the microaerophilic treatment tank communication chamber 35c is temporally reserved in the microaerophilic treatment tank communication chamber 35c by being blocked by the baffle board 35a since the water flow orifice 35f controls the water flow rate. The discharged water beyond the capacity of the microaerophilic treatment tank communication chamber 35c will overflow through the low section 35b of the baffle board 35a into the aerobic treatment tank communication chamber 35d, followed by flowing out into the aerobic treatment tank 32.

If the physical filtering medium 52 is clogged, an excessive discharged water of the aquarium flown in through the insertion opening 36a of the connection tube will flow out from the discharged water flow-out section 35h formed at the side of the aerobic treatment tank communication chamber 35d of the physical filtering medium container 35 into the reserving section 30k in which the water supply pump 54 is disposed, thereby being returned to the aquarium 1 with a help of the water supply pump 54. With the above stated structure, it is possible to prevent the discharged water of the aquarium which could not pass through the physical filtering medium 52 from overflowing to the outside of the cover 36.

Through the water flow orifice 35f of the microaerophilic treatment tank communication chamber 35c of the physical filtering medium container 35, the discharged water of the aquarium flows into the introduction passage 30e at a slow speed to further flow into the microaerophilic treatment chamber 30b through the distribution opening 30f at a lower section of the partition board 30d. The discharged water of the aquarium temporally resides in each of the introduction passage 30e for the discharged water of the aquarium and the microaerophilic treatment chamber 30b until it flows into the microaerophilic treatment tank 31. The water flow orifice 35f of the physical filtering medium container 35 has a diameter which can optimize the rate of the discharged water from the aquarium, and therefore the discharged water flows down into the introduction passage 30e without involving the ambient air.

While the discharged water of the aquarium flows through the introduction passage 30e into the microaerophilic treatment tank 31, air contained in the discharged water of the aquarium will naturally be deaerated therefrom, resulting in the reduced dissolved oxygen rate in the discharged water of the aquarium. Consequently, the introduction passage 30e for the discharged water of the aquarium is provided a length (height) sufficient to deaerate the air in the discharged water of the aquarium.

The discharged water of the aquarium in the microaerophilic treatment chamber 30b flows into the microaerophilic treatment tank 31 through the water through openings 31a in the bottom surface of the microaerophilic treatment tank 31 and flows up through spaces between a number of clinker ashes 31d. As described above, the discharged water of the aquarium flows from a lower section to an upper section of the microearophilic treatment tank 31, such that the discharged water of the aquarium is distributed over the clinker ashes 31d to be flown over the entirety of the treatment tank 31 uniformly, resulting in an enhanced contact efficiency with and filtering effect by the clinker ashes 31d. Air remaining in the spaces between the clinker ashes can go up together with the discharged water of the aquarium to finally be deaerated with ease. Because the aerobes attached naturally to the clinker ashes 31d breathe oxygen, dissolved oxygen in the discharged water of the aquarium can be consumed.

According to an synergetic effect of the above stated phenomenon, the discharged water of the aquarium in the microaerophilic treatment tank 31 is kept in a microaerophilic condition; however, the dissolved oxygen rate in the microaerophilic treatment tank 31 gradually lowers from the lower section to the upper section of the tank. Here, the dissolved oxygen rate near the culture bed container 33 in the microaerophilic treatment tank 31 is between 4 mg/L and 5 mg/L.

The discharged water of the-aquarium which passed through the clinker ashes 31d flows into the culture bed container 33 through the water through openings 33a of the container 33, followed by being subjected to the denitrification treatment mostly by the denitrifiers in the culture bed 50. The denitrifiers, such as the sulfur oxidation denitrifiers, held in the culture bed 50 are facultative anaerobes which work actively under the microaerophilic condition, namely, which consume nitrate ion and nitrite ion contained in the discharged water of the aquarium to change them into nitrogen gas. According to the denitrification treatment, the concentration of the nitrate and the nitrite in the discharged water of the aquarium can be lowered.

The treatment water having passed through the culture bed 50 flows through the inclined surface 33c of the culture bed container 33 into the pH control materials container 34 of the side of the aerobic treatment tank 32. There are cases where the treatment water in the microaerophilic treatment tank 31 still includes nitrite ion hazardous to the aquarium fish. Therefore, it is necessary to subject the treatment water to re-treatment in the aerobic treatment tank 3 in order to change the hazardous nitrite ion to nonhazardous nitrate ion. The treatment water in the microaerophilic treatment tank 31 looses its pH balance due to the denitrification treatment, such that it is necessary for the treatment water to be conditioned to have an optimum pH value.

The discharged water of the aquarium from the physical filtering medium container 35 and the treatment water having passed through the culture bed container 33 flow into the pH control materials container 34, in which the discharged water and the treatment water are brought into contact with the pH control materials 51 such as calcium carbonate to be conditioned to have such a pH value (pH 6-8) that is optimum for aerobic treatment and to raise the aquarium fish. Water having passed through the pH control materials 51 flows into the aerobic treatment tank 32 though the water through openings 34a.

In the aerobic treatment tank 32, while the discharged water of the aquarium (including the treatment water of the microaerophilic treatment tank 31) flows downwardly through the spaces between the clinker ashes 32d, the ammonia component contained in the discharged water of the aquarium is changed from the nitrite ion to the nitrate ion owing to the oxygen breathing of the nitrification bacteria (aerobes) carried by the clinker ashes 32d, thereby decomposing the ammonia component which is the case of an unpleasant order. The treatment water of the aerobic treatment tank 32 flows out from the water through openings 32a in the bottom surface of the tank to be reserved in the reserving section 30k next to the aerobic treatment tank 32. Here, the dissolved oxygen rate of the aerobic treatment tank 32 is between 6 mg/L and 8 mg/L.

If the pH control materials 51 of the aerobic treatment tank 32 is clogged, the excessive discharged water of the aquarium from the physical filtering medium container 35, as shown in FIG. 3, flows out from a space flow passage 55 formed between the bottom surface of the physical filtering medium container 35 and the upper surface of the pH control materials container 35 into the reserving section 30k. Accordingly, the excessive discharged water of the aquarium is prevented from flowing out into the side of the culture bed container 33 of the microaerophilic treatment tank 31.

Water drops as a result of a splash of water from the insertion opening 36a of the connection tube and water drops as a result of evaporation of water attaches to the back surface of the cover 36. Those water drops move in an end-and-edge direction of the back surface of the cover to drop downwardly along the water drop guiding piece 36e. Therefore, water drops would not leak to the outside through the periphery 36d of the cover 36.

The treatment water flown out into the reserving section 30k, as shown in FIG. 1, is pumped up by the water supply pump 54, through the connection tube 41e, rising in the water supply diverging tube 41 of the lower water flow tube 41 and the water supply tube 40c of the upper water flow tube 40, and returned to the aquarium 1 through the water discharge tube 40e.

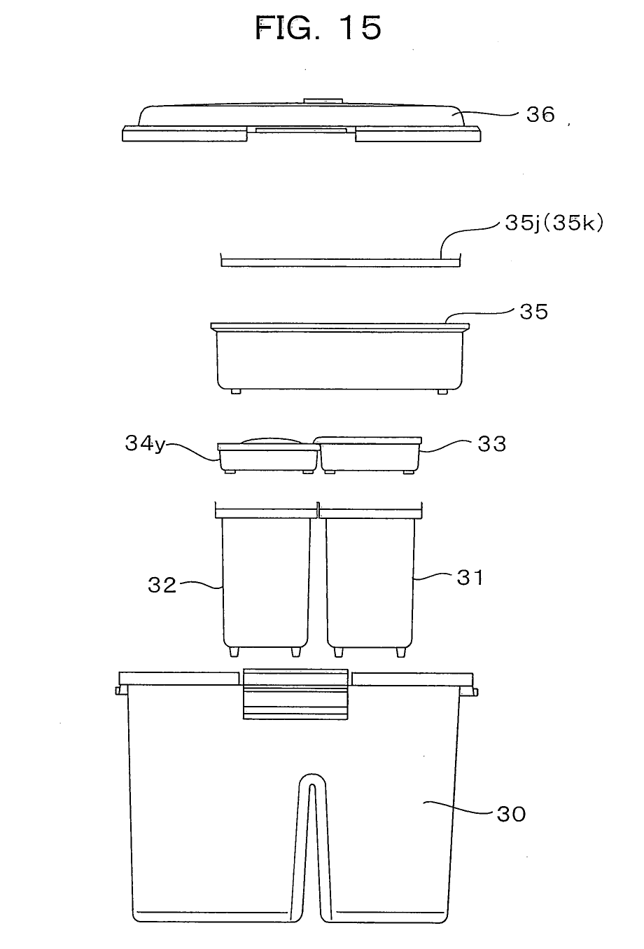

FIG. 15 shows an embodiment in which the invention is applied to the aquarium purifier for breeding sea fish and shellfish, invertebrates such as actiniae or the like, and the other sea livings. This aquarium purifier has the same basic structure as it is described above, namely, it includes the outer case 30, the microaerophilic treatment tank 31, the aerobic treatment tank 32, the culture bed container 33, a mineral control materials container 34y, the physical filtering medium container 35, and the cover 36.

The culture bed container 33 contains the sulfur-calcium substrate culture bed 50 by an amount (for example, 500g) larger than that in the case of fresh water, and the denitrification treatment is performed here satisfactory (for example, 50 ppm nitrate in fresh water is reduced to 10 ppm). The mineral control materials container 34y contains a phosphate absorption material such as activated alumina (for example, by 300g), and therefore phosphoric acid (phosphate) contained in the discharged water of the aquarium flown into the aerobic treatment tank 32 can be removed satisfactory. Accordingly, the invention is applicable to the livings, such as the invertebrates including actiniae and the like, which are specially sensitive to the nitrate and the phosphoric acid (phosphate).

The microaerophilic treatment tank 31 and the aerobic treatment tank 32 are filled with coral particles (for example, 2 kg for each tank), and the coral particles of the aerobic treatment tank 32 hold nitrification bacteria. Accordingly, calcium carbonate contained in the coral particles is solved out into the treated seawater to keep the seawater at the pH value (for example, between 7.5 and 8.5) optimum to the sea livings to live therein. The physical filtering medium 52 of and its amount in the physical filtering medium container 35 are set to the same one and the same value as they are used in the fresh water.

The above described embodiments are only the examples of the invention, and thus it should be appreciated that structures of the aquarium purifier and the others will not be limited to those having been illustrated, but can be modified as required.

### EXAMPLE 1

Researched were concentration changes of the ammonia, the nitrite, and the nitrate of the reserved water in the aquarium in which the aquarium purifier of the invention was used. The aquarium purifier in the research was the one typically illustrated in FIG. 6, in which the microaerophilic treatment tank 31 and the aerobic treatment tank 32 were filled with clinker ashes and the aerobic treatment tank 32 was provided with commercially available nitrification bacteria mixed therein. As for the culture bed 50, sulfur-calcium substrate fine porous particle matters holding commercially available sulfur-oxidizing denitrifiers were used. As for the pH control materials, calcium carbonate was used. As for the physical filtering medium 52, the one having double-layered structure composed of activated carbon for an upper layer and artificial zeolite for a lower layer was used. The aquarium 1 was filled with fresh water and provided with 50 aquarium fish.

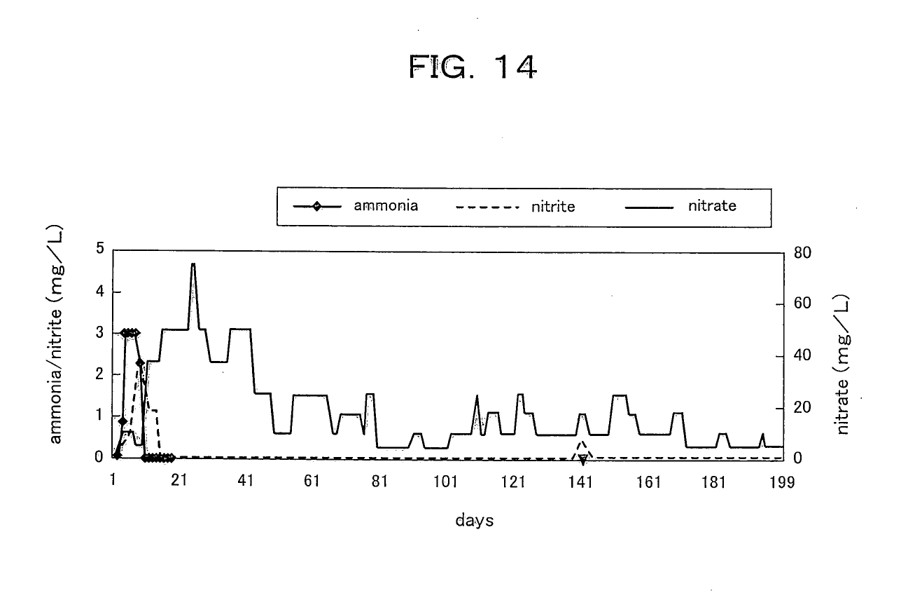

As a result of the research, a concentration of each of the ammonia, the nitrite, and the nitrate in the reserved water of the aquarium could be kept at a low level for a long time period (200 days in the test) as shown in FIG. 14, during which, no water exchange was necessary except for filling up for evaporated water.

### EXAMPLE 2

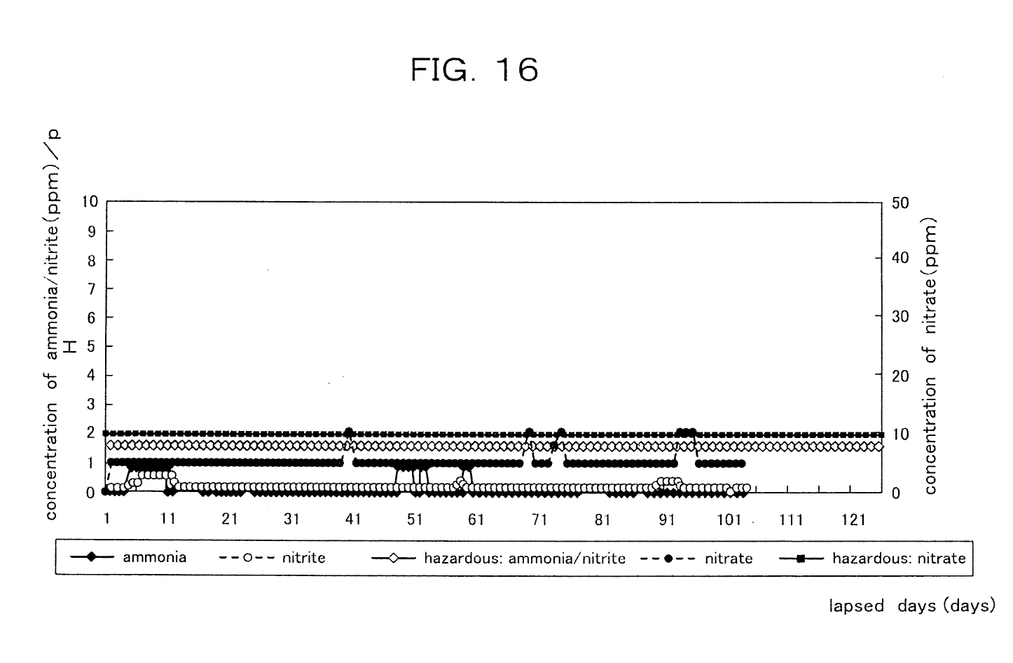

Researched were concentration changes of the ammonia, the nitrite, and the nitrate in the reserved water of the aquarium for 100 days under the conditions that the aquarium purifier as described in FIG. 15 was used, the aquarium 1 was filled with seawater, and the aquarium was provided with 50 blue-green-pullers and 2 entacmaea ramsayis (about 10 to 15 cm large) for breeding those in the aquarium. As a result thereof, all of the components could be kept stably at a low level as shown in FIG. 16. Similar to the case using the fresh water, no water exchange was needed except for filling up for evaporated water during the research.

Embodiments also embraced within the scope of the invention other than the inventions recited in the claims will be summarized below.

An aquarium purifier for purifying reserved water in an aquarium including: physical filtering device for filtering discharged water of the aquarium; denitrification treatment device for the discharged water of the aquarium; nitrification treatment device for the discharged water of the aquarium; and water quality control device for the discharged water of the aquarium.

The physical filtering device physically removes foreign matters such as excretory substance, left-over food, and dust of the aquarium fish in the discharged water of the aquarium, removes calcium ion in the discharged water of the aquarium and discharges sodium ion and hydrogen ion to keep the discharged water of the aquarium soft water. Device therefor may be optional here and thus, for example, a granular or film-like ion exchange resin, an artificial or natural zeolite, or an activated carbon can be used. The denitrification treatment and the nitrification treatment are as they are described above. The water quality controll device includes an electrolyte controlling, an odor controlling, or the like, in addition to the pH controlling and a mineral controlling which will be described below.

The invention includes: a flow passage which guides the discharged water of the aquarium to the denitrification treatment device and the nitrification treatment device, respectively, through the physical filtering device; and a flow passage which guides treatment water having passed through the denitrification treatment device and the discharged water of the aquarium having passed through the physical filtering device to the nitrification treatment device through the water quality control device.

With the above described structure, the denitrification treatment requiring a longer treatment period and the nitrification treatment requiring shorter treatment period than that of the denitrification treatment can be performed separately after the discharged water of the aquarium is subjected to the physical filtering device in order to remove the foreign matters and to absorb ion (ion exchange). Since the nitrate ion and the nitrite ion increase in the denitrification treatment, the treatment water loosing pH balance can be controlled by water quality adjustment materials device together with the discharged water of the aquarium having passed through the physical filtering device to have water quality suitable for the nitrification treatment and for the aquarium livings.

According to the invention, the denitrification treatment device includes the culture bed holding the denitrifiers and in which the discharged water of the aquarium under the low dissolved oxygen condition is brought into contact with the culture bed. The denitrifiers, its culture bed, and the low dissolved oxygen condition have been explained above.

According to the invention, the nitrification treatment device includes the culture bed holding the nitrification bacteria and in which the discharged water of the aquarium under the high dissolved oxygen condition is brought into contact with the culture bed. The nitrification bacteria, its culture bed and the high dissolved oxygen condition have been exfreshed above.

According to the invention, the physical filtering device includes the ion adsorption material (ion exchange material). As for the ion adsorption material, the ion exchange resin, the artificial or natural zeolite, the activated carbon, or the like, can be used.

According to the invention, the water quality control device includes the pH control materials. The pH control materials works to pH-condition the discharged water of the aquarium which lost the pH balance due to an increase of the nitrate ion, the nitrite ion, and the like. The pH control materials is not limited to these, but could be limes, shells, or the like. Preferably, the pH control materials is the calcium carbonate.

According to the invention, the water quality control device includes the mineral control materials. Preferably, the mineral control materials is the phosphate adsorption material.

According to the invention, the denitrification treatment device has a structure in which sulfur oxidation denitrifiers are carried by the culture bed made of sulfur-calcium substrate. Preferably, the denitrification treatment device has a structure in which air contained in the discharged water of the aquarium is naturally released and then the discharged water of the aquarium under the low dissolved oxygen condition is brought into contact with the culture bed.

According to the invention, the denitrification treatment device and the nitrification treatment device serve to distribute water flow through a porosity filtering medium. The porosity filtering medium is selected from the clinker ashes, the filtering medium composed mainly of calcium carbonate, the coral particles, and the like. The nitrification treatment device has a structure in which the nitrification bacteria are held in the porosity filtering medium.

The aquarium purifier of the invention is the one for purifying the reserved water of the aquarium including: an outer case which is separated into a microaerophilic treatment chamber having an introduction passage of the discharged water of the aquarium and an aerobic treatment chamber; a microaerophilic treatment tank and an aerobic treatment tank which are stored in the microaerophilic treatment chamber and the aerobic treatment chamber of the outer case, respectively; a culture bed container to be placed in the microaerophilic treatment tank and a water quality control materials container to be placed in the aerobic treatment tank; a physical filtering medium container which is placed above the microaerophilic treatment tank and the aerobic treatment tank and which is separated into the microaerophilic treatment tank communication chamber and the aerobic treatment tank communication chamber; and a cover for the outer case.

With such a structure, since the microaerophilic treatment tank, the aerobic treatment tank, the culture bed container, the water quality control materials container, and the physical filtering medium container can all together be packed within the outer case, the aquarium purifier of the invention can be assembled with ease, is compact in its entirety, can save an installation space, and has a good appearance. Shapes and the other conditions of those components are not limited here; however, if all of the components are formed into a box-shape, they can be well packed in the outer case and can assemble with ease.

According to the invention, the outer case is separated into the microaerophilic treatment chamber and the aerobic treatment chamber by the projecting partition formed such that the bottom surface projects into the inside of the outer case. With such a structure, the outer case can be formed into one piece by the injection molding, such that no leakage is seen with respect to the separation in comparison with such a method in which a separation made of a separate member is secured by an adhesion or the like.

The invention includes at least the outer case, the microaerophilic treatment tank, and the aerobic treatment tank which are formed into one piece by the injection molding. Those are the main components of the invention which can keep an uniform flow of the discharged water of the aquarium and the treatment water if they can be mass-produced with precision by the injection molding. Further, since no solvent is used for securing the components, no adverse effect on the aquarium fish will occur.

The aquarium purifier system of the invention includes: an aquarium; an aquarium purifier for purifying reserved water in the aquarium; and water convey device which circulates the reserved water in the aquarium between the aquarium and the aquarium purifier; in which the aquarium purifier is one of the above listed water purifiers.

The water convey device includes a water flow tube which connects the aquarium with the aquarium purifier and a water convey (supply) pump, in which the discharged water of the aquarium is introduced into the aquarium purifier through the water flow tube and treatment water having been subjected to the purification treatment is returned from the aquarium purifier to the aquarium by device of the water convey pump.

What is claimed is:

1. An aquarium purifier for purifying reserved water in an aquarium comprising:
a microaerophilic treatment tank and an aerobic treatment tank which microbiologically treat discharged water from the aquarium.

2. The aquarium purifier as claimed in claim 1, further comprising an a deaeration device which naturally releases air out of the discharged water flowing in an introduction passage for the discharged water of the aquarium, the introduction passage communicating with the microaerophilic treatment tank.

3. The aquarium purifier as claimed in claim 2, wherein the deaeration device controls a flow rate at the introduction passage for the discharged water of the aquarium and the controlled flow rate of the discharged water of the aquarium is introduced from a lower section of the microaerophilic treatment tank through the introduction passage.

4. The aquarium purifier as claimed in claim 1, wherein the microaerophilic treatment tank is provided with a culture bed containing a nutrient source necessary for denitrifiers.

5. The aquarium purifier as claimed in claim 4, wherein the denitrifiers are sulfur-oxidizing denitrifiers and the nutrient source is a sulfur-calcium substrate.

6. The aquarium purifier as claimed in claim 1, wherein each of the microaerophilic treatment tank and the aerobic treatment tank is filled with a porosity filtering medium, and the porosity filtering medium of the aerobic treatment tank holds aerobes.

7. The aquarium purifier as claimed in claim 6, wherein the aerobes are mostly nitrifiers.

8. The aquarium purifier as claimed in claim 1, wherein the aerobic treatment tank is provided with a water quality control materials.

9. An aquarium purification method for purifying reserved water in an aquarium comprising the steps of:
treating the discharged water of the aquarium under a microbiologically microaerophilic condition; and
treating the discharged water of the aquarium under an aerobic condition.

10. The aquarium purification method as claimed in claim 9, further comprising the steps of:
nitrification treating the discharged water of the aquarium in the step of the aerobic treatment, and returning the treatment water to the aquarium;
denitrification treating the discharged water of the aquarium in the step of the microaerophilic treatment, and removing the treatment water to the step of the aerobic treatment.

11. The aquarium purification method as claimed in claim 9, wherein dissolved oxygen rate in the microaerophilic treatment is 5 mg/L or less.
